(19) United States
(12) Patent Application Publication
(10) Pub. No.: US 2026/0081392 A1
(43) Pub. Date: Mar. 19, 2026

(54) BUSBAR CONNECTOR

(71) Applicant: Bellwether Electronic Corp., Taoyuan City (TW)

(72) Inventors: Jimmy Enrique ACERA, Taoyuan City (TW); Chih-Ming TSAI, Taoyuan City (TW)

(21) Appl. No.: 18/938,302

(22) Filed: Nov. 6, 2024

(30) Foreign Application Priority Data
Sep. 13, 2024 (TW) 113134981

(51) Int. Cl. H01R 25/14; H01R 13/24; H01R 13/436

(52) U.S. Cl. CPC H01R 25/142; H01R 13/2457; H01R 13/4361

(57) ABSTRACT

A busbar connector includes two bodies and two conductive slices. Each body is in a flat-plate form. The bodies are opposite to and spaced apart from each other. Each conductive slice is disposed on the corresponding body. The conductive slices face to and are spaced apart from each other. Each conductive slice includes a conductive frame, some first conductive arms and some second conductive arms. The conductive frame connects with the body and has an inner edge. The first conductive arms connect with the inner edge and respectively curve convexly towards another conductive slice. The second conductive arms connect with the inner edge and respectively curve convexly towards another conductive slice. The first and the second conductive arms extend in opposite directions and are staggered relative to each other. A thickness ratio of the bodies to the conductive frames is greater than or equal to 3.

### RELATED APPLICATIONS

This application claims priority to Taiwanese Application Serial Number 113134981, filed Sep. 13, 2024, which is herein incorporated by reference in its entirety.

### BACKGROUND

### Technical Field

The present disclosure relates to busbar connectors.

### Description of Related Art

With the rapid advancement of science and technology nowadays, the application of artificial intelligence has become more popular, and the related energy consumption is also increasing every year. In the server industry, busbar connectors are commonly used connectors. In order to support the applications of artificial intelligence, busbar connectors have to reach higher rated currents in a short period of time. Therefore, in order to improve the development and sustainability of artificial intelligence, how to enable busbar connectors to withstand higher currents to maintain the power required for the operations by artificial intelligence is undoubtedly an important issue that the industry highly concerns.

### SUMMARY

A technical aspect of the present disclosure is to provide a busbar connector, which can effectively increase the allowable magnitude of current flowing through therein.

According to an embodiment of the present disclosure, a busbar connector includes two bodies and two conductive slices. The bodies respectively are in a flat plate form. The bodies are opposite to and spaced apart from each other. Each of the conductive slices is disposed on a corresponding one of the bodies. The conductive slices face to and are spaced apart from each other. Each of the conductive slices includes a conductive frame, a plurality of first conductive arms and a plurality of second conductive arms. The conductive frame is connected with the body and has a first inner edge. The first conductive arms are connected with the first inner edge and extend at least partially along a first direction. Each of the first conductive arms at least partially curves convexly towards another one of the conductive slices. The second conductive arms are connected with the first inner edge and extend at least partially along a second direction. The second direction is opposite to the first direction. Each of the second conductive arms at least partially curves convexly towards another one of the conductive slices. The first conductive arms and second conductive arms are staggered relative to each other. A thickness ratio of the bodies to the conductive frames is greater than or equal to 3.

In one or more embodiments of the present disclosure, the first conductive arms and the second conductive arms are alternately arranged along a third direction. The third direction is perpendicular to the first direction and the second direction.

In one or more embodiments of the present disclosure, each of the first conductive arms has a first contact zone. The first contact zones are arranged in a row. Each of the second conductive arms has a second contact zone. The second contact zones are arranged in a row. The first contact zones and the second contact zones are staggered relative to each other along the first direction.

In one or more embodiments of the present disclosure, the conductive frame of each of the conductive slices has a second inner edge. The second inner edge and the first inner edge are arranged along the first direction and spaced apart from each other. Each of the conductive slices further includes a plurality of third conductive arms and a plurality of fourth conductive arms. The third conductive arms are connected with the second inner edge and extend at least partially along the first direction. Each of the third conductive arms at least partially curves convexly towards another one of the conductive slices. The fourth conductive arms are connected with the second inner edge and extend at least partially along the second direction. Each of the fourth conductive arms at least partially curves convexly towards another one of the conductive slices. The third conductive arms and fourth conductive arms are staggered relative to each other.

In one or more embodiments of the present disclosure, the third conductive arms and the fourth conductive arms are alternately arranged along the third direction. The third direction is perpendicular to the first direction and the second direction.

In one or more embodiments of the present disclosure, each of the first conductive arms has a first contact zone. The first contact zones are arranged in a row. Each of the second conductive arms has a second contact zone. The second contact zones are arranged in a row. Each of the third conductive arms has a third contact zone. The third contact zones are arranged in a row. Each of the fourth conductive arms has a fourth contact zone. The fourth contact zones are arranged in a row. The first contact zones, the second contact zones, the third contact zones and the fourth contact zones are staggered relative to each other along the first direction.

In one or more embodiments of the present disclosure, each of the bodies includes a conductive plate. The conductive plate has a mounting groove to support at least a portion of the conductive frame.

In one or more embodiments of the present disclosure, each of the conductive slices further includes a positioning slice. The positioning slice is formed by bending and extending from a side of the conductive slice.

According to an embodiment of the present disclosure, a busbar connector includes a housing, two bodies and two conductive slices. The housing has a slot. The bodies respectively are in a flat plate form. The bodies are opposite to and spaced apart from each other. The bodies are partially exposed from the slot. Each of the conductive slices is disposed on a corresponding one of the bodies. The conductive slices face to and are spaced apart from each other. The conductive slices are partially exposed from the slot. Each of the conductive slices includes a conductive frame and a plurality of conductive arms. The conductive arms extend convexly inwards from an inner edge of the conductive frame. A thickness ratio of the bodies to the conductive frames is greater than or equal to 3.

In one or more embodiments of the present disclosure, each of the bodies has a plurality of mounting grooves. At least two side edges of each of the conductive slices are mounted at the mounting grooves.

In one or more embodiments of the present disclosure, each of the conductive slices includes a positioning slice. The positioning slice is formed by bending and extending from a side of a corresponding one of the conductive slices. The positioning slice abuts an end of a corresponding one of the bodies when a corresponding one of the conductive slices is mounted at the mounting grooves.

In one or more embodiments of the present disclosure, the conductive arms have at least two rows of contact zones staggered relative to each other.

In one or more embodiments of the present disclosure, the housing is disposed with two grounding slices at each of two outer sides of the slot. Each of the grounding slices is spaced apart from the bodies.

In one or more embodiments of the present disclosure, each of the bodies further includes a conductive plate and at least one conductive extending piece. A corresponding one of the conductive slices is disposed on the conductive plate. The conductive extending piece is connected with a side of the conductive plate away from the corresponding one of the conductive slices.

In one or more embodiments of the present disclosure, each of the bodies further includes at least one conductive connecting piece. A quantity of the conductive extending piece is plural. The conductive connecting piece penetrates through and fixes the conductive extending pieces.

In one or more embodiments of the present disclosure, the conductive connecting piece includes a bolt and a nut.

In one or more embodiments of the present disclosure, the housing includes a plurality of positioning structures therein. Each of the bodies further includes a plurality of positioning elastic arms. The positioning elastic arms are disposed on a side of the conductive extending piece away from the conductive plate. Each of the positioning elastic arms extends along an extending direction of the conductive extending piece and is at least partially lifted up relative to the conductive extending piece. Each of the positioning elastic arms is configured to snap with a corresponding one of the positioning structures.

In one or more embodiments of the present disclosure, the busbar connector further includes two grounding slices. The grounding slices are disposed on the housing at two outer sides of the slot. Each of the grounding slices has an L shape.

In one or more embodiments of the present disclosure, the slot has a front opening and two side openings communicated with the front opening.

The above-mentioned embodiments of the present disclosure have at least the following advantages:
(1) When the busbar connector is used, the conductive portion of another connector is inserted between the conductive slices, and the conductive portion abuts against the convexly curved portions of the first conductive arms, the second conductive arms, the third conductive arms and the fourth conductive arms respectively, such that the quantity of contact points between the conductive portion and the conductive slices for the flow of an electric current can be effectively increased, and the allowable magnitude of current flowing through the busbar connector is effectively increased.
(2) Since each of the conductive slices has a flat form to provide a plurality of electrical contact points and so has a thinner thickness, in compliance with the size specifications of a busbar connector to be used in a server unit, each of the conductive plates can have a thicker thickness, which allows each of the conductive plates to have a larger cross-sectional area for a better support for higher currents.

### BRIEF DESCRIPTION OF THE DRAWINGS

The disclosure can be more fully understood by reading the following detailed description of the embodiments, with reference made to the accompanying drawings as follows:

FIG. 1 is a schematic view of a busbar connector according to an embodiment of the present disclosure;

FIG. 2 is a schematic view of the busbar connector of FIG. 1, in which the housing is omitted;

FIG. 3 is a sectional view along the sectional line A-A of FIG. 1;

FIG. 4 is a sectional view along the sectional line B-B of FIG. 3;

FIG. 5 is a sectional view along the sectional line C-C of FIG. 3; and

FIG. 6 is a schematic view showing the way to install the conductive slice to the conductive plate of FIG. 1.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

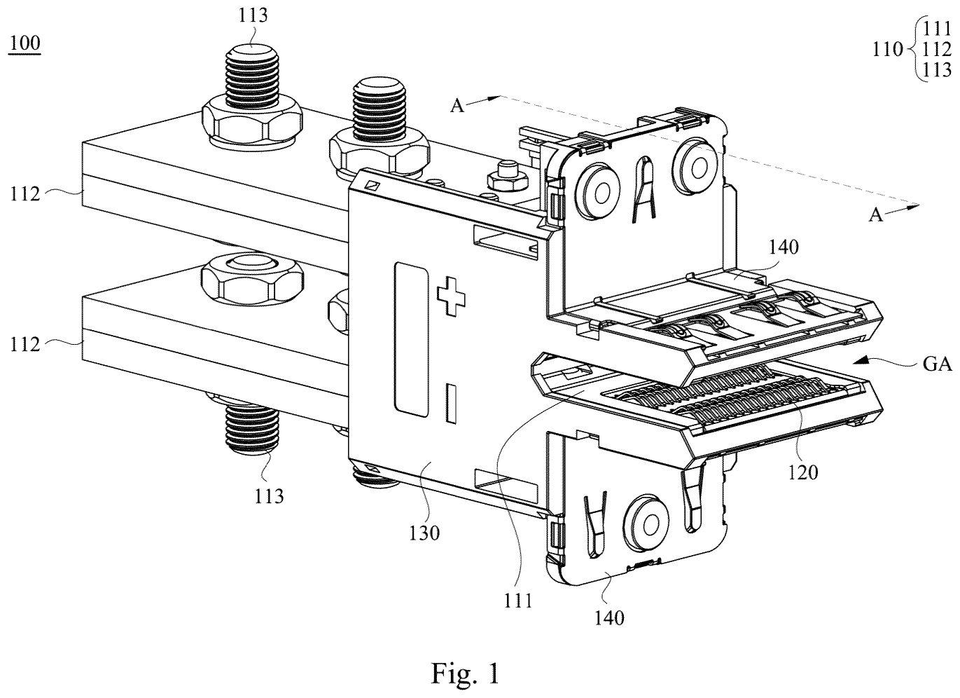

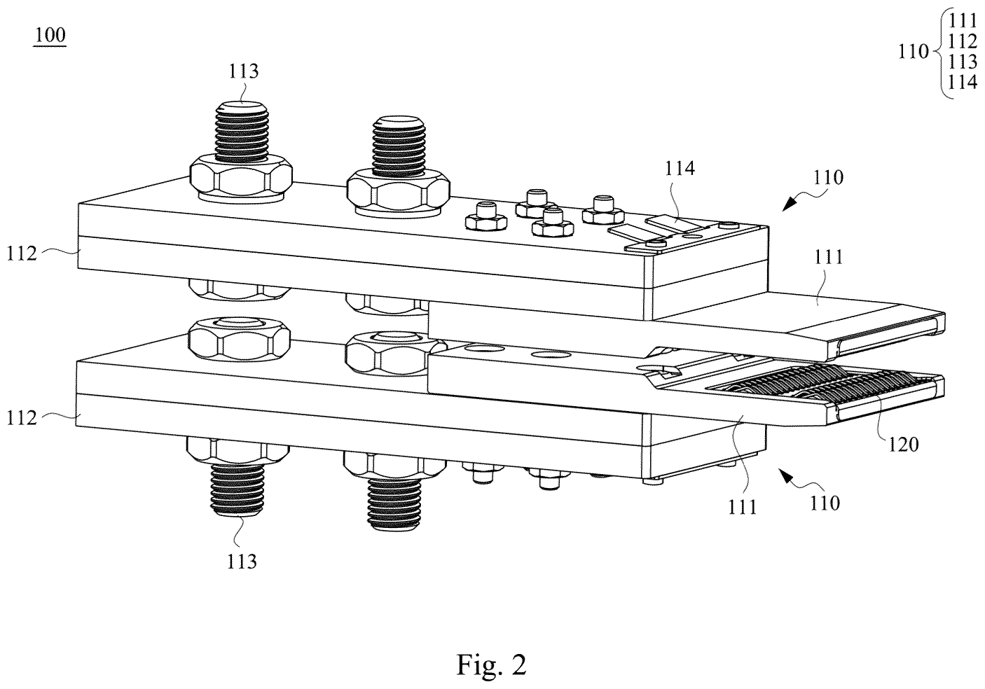

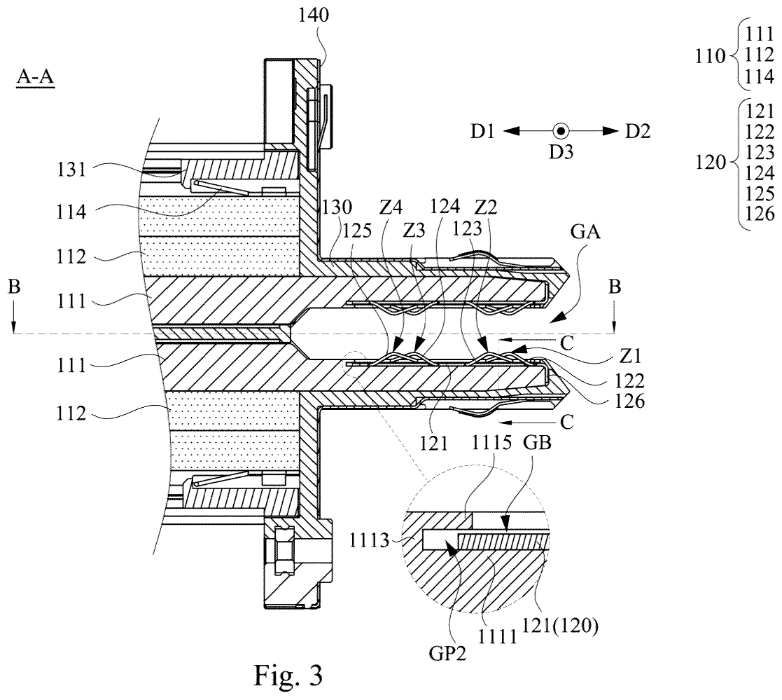

Reference is made to FIGS. 1-2. FIG. 1 is a schematic view of a busbar connector 100 according to an embodiment of the present disclosure. FIG. 2 is a schematic view of the busbar connector 100 of FIG. 1, in which the housing 130 is omitted. In this embodiment, as shown in FIGS. 1-2, a busbar connector 100 includes two bodies 110, two conductive slices 120 (please refer to FIG. 3 for one of the two conductive slices 120 being blocked in FIGS. 1-2) and a housing 130. The bodies 110 respectively are in a flat plate form. The bodies 110 face to and are spaced apart from each other for electrical isolation. The conductive slices 120 also face to and are spaced apart from each other for electrical isolation. The bodies 110 and the conductive slices 120 are independent of each other. Each of the conductive slices 120 is disposed on an inner side of a corresponding one of the bodies 110 for electrical connection. The housing 130 is connected with the bodies 110 and at least partially surrounds the bodies 110 and the conductive slices 120. In addition, the housing 130 has a slot GA for the conductive portion of another connector (not shown) to insert into. The slot GA has a front opening and two side openings communicated with the front opening. A portion of each of the bodies 110 and the conductive slices 120 are located inside the slot GA. The busbar connector 100 further includes two grounding slices 140. The grounding slices 140 respectively have an L shape. The grounding slices 140 are disposed on the housing 130 at two outer sides of the slot GA. The housing 130 can have two wings laterally extending from two sides, respectively. The grounding slices 140 are also disposed on two front side surfaces of the two wings, respectively. Each of the bodies 110 includes a conductive plate 111, at least one conductive extending piece 112 and a plurality of positioning elastic arms 114. The conductive plates 111 are spaced apart from each other. Each of the conductive plates 111 is connected with a corresponding one of the conductive extending piece 112, and the conductive plates 111 may be at least partially located between the conductive extending pieces 112. At least two conductive extending pieces 112 are divided into two groups. Each group of the conductive extending piece(s) 112 is spaced apart from another group and is connected with a corresponding one of the conductive plates 111. Each group of the conductive extending piece(s) 112 can include a plurality of the conductive extending pieces 112. Each of the bodies 110 can include a plurality of conductive connecting pieces 113. The conductive connecting pieces 113 respectively fix the conductive extending pieces 112 of each group together. Each of the conductive connecting pieces 113 is disposed on the conductive extending pieces 112 and is away from the conductive plate 111. In practice, each of the conductive connecting pieces 113 can be a combination of a bolt and a nut. However, this does not intend to limit the present disclosure. Moreover, the positioning elastic arms 114 are also divided into two groups. Each group of the positioning elastic arm(s) 114 is disposed on a side of a corresponding one of the groups of the conductive extending pieces 112 away from a corresponding one of the conductive plates 111. In some embodiments, each group of the positioning elastic arm(s) 114 may be disposed on a side of a corresponding one of the conductive plates 111. Each group of the positioning elastic arm(s) 114 can include a plurality of the positioning elastic arms 114. Each of the positioning elastic arms 114 extends along a first direction D1 (please refer to FIG. 3 for the first direction D1) and is at least partially lifted up relative to the conductive extending pieces 112. The first direction D1 is a mating direction of another connector to insert into the slot GA. In this way, after the bodies 110 are installed into the housing 130, each of the positioning elastic arms 114 can be snapped with a corresponding one of the positioning structures 131 inside the housing 130, which can prevent the bodies 110 from detaching from housing 130. In the application of the busbar connector 100, the conductive extending pieces 112 are connected with cables (not shown), and the conductive portion of another connector (not shown) is inserted between the conductive slices 120, such that an electrical connection is formed. For example, the busbar connector 100 is suitable to be used for servers for electrical transmission.

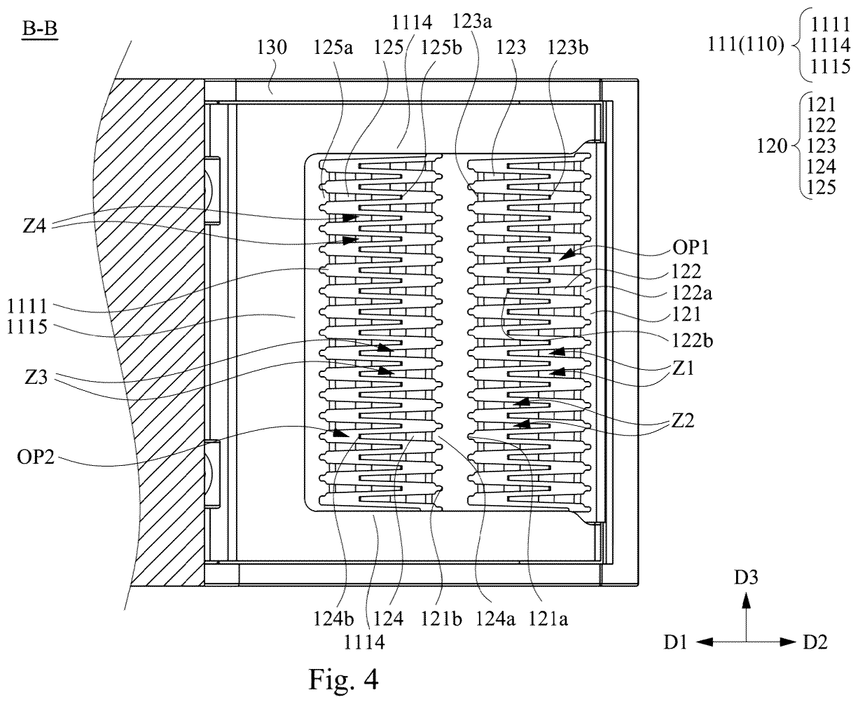

Reference is made to FIGS. 3-4. FIG. 3 is a sectional view along the sectional line A-A of FIG. 1. FIG. 4 is a sectional view along the sectional line B-B of FIG. 3. In this embodiment, as shown in FIGS. 3-4, each of the conductive slices 120 includes a conductive frame 121, a plurality of first conductive arms 122 and a plurality of second conductive arms 123. The conductive frame 121 is located on at least two side edges of the conductive slice 120. Each of the conductive slices 120 has an opening OP1. A perimeter of the opening OP1 is surrounded by four side edges that forms a first inner edge 121a. In this embodiment, the opening OP1 has a square shape. The conductive frame 121 is connected with the body 110 and has the first inner edge 121a. The first conductive arms 122 are connected with the first inner edge 121a and extend at least partially along the first direction D1. Each of the first conductive arms 122 at least partially curves convexly towards another one of the conductive slices 120. The second conductive arms 123 are connected with the first inner edge 121a and extend at least partially along a second direction D2. The second direction D2 is opposite to the first direction D1. Each of the second conductive arms 123 at least partially curves convexly towards another one of the conductive slices 120. The first conductive arms 122 and second conductive arms 123 are staggered relative to each other. In practice, when the conductive portion of another connector is inserted between the conductive slices 120, the conductive portion abuts against the convexly curved portions of the first conductive arms 122 and the second conductive arms 123 respectively, such that the first conductive arms 122 and the second conductive arms 123 are at least partially deformed elastically, and the connecting stability of the conductive portion to the first conductive arms 122 and the second conductive arms 123 is increased. The convexly curved portions of the first conductive arms 122 and the second conductive arms 123 are respectively the first contact zones Z1 and the second contact zones Z2. The first contact zones Z1 of the first conductive arms 122 are arranged in a row. The second contact zones Z2 of the second conductive arms 123 are also arranged in a row. In the first direction D1, a distance from the first contact zones Z1 of the first conductive arms 122 to their fixed ends is longer than a distance to their free ends, but shorter than a distance to the fixed ends of the second conductive arms 123, while a distance from the second contact zones Z2 of the second conductive arms 123 to their fixed ends is longer than a distance to their free ends, but shorter than a distance to the fixed ends of the first conductive arms 122. Therefore, the first contact zones Z1 of the first conductive arms 122 and the second contact zones Z2 of the second conductive arms 123 are staggered relative to each other. When the conductive portion is inserted, the conductive portion firstly contacts with the first contact zones Z1 of the first conductive arms 122, and then the second contact zones Z2 of the second conductive arms 123. In this way, the insertion and extraction force required when the conductive portion is inserted into or extracted from between the conductive slices 120 can be reduced. In some embodiments, the conductive portion firstly contacts with the second contact zones Z2 of the second conductive arms 123, and then the first contact zones Z1 of the first conductive arms 122. In other words, in the first direction D1, a distance from the first contact zones Z1 of the first conductive arms 122 to their fixed ends is longer than a distance to their free ends and also a distance to the fixed ends of the second conductive arms 123, while a distance from the second contact zones Z2 of the second conductive arms 123 to their fixed ends is longer than a distance to their free ends and also a distance to the fixed ends of the first conductive arms 122.

To be specific, as shown in FIG. 4, each of the first conductive arms 122 has a first end 122a and a second end 122b opposite to the first end 122a. The first end 122a of each of the first conductive arms 122 is a fixed end and is connected with the first inner edge 121a of the conductive frame 121. The second end 122b of each of the first conductive arms 122 is a free end. This means the second ends 122b do not contact the conductive frame 121. A width of each of the first conductive arms 122 along a third direction D3 gradually narrows from the first end 122a to the second end 122b (i.e., from the fixed end to the free end). The third direction D3 is perpendicular to the first direction D1 and the second direction D2. Each of the second conductive arms 123 has a third end 123a and a fourth end 123b opposite to the third end 123a. The third end 123a of each of the second conductive arms 123 is a fixed end and is connected with the first inner edge 121a of the conductive frame 121. The fourth end 123b of each of the second conductive arms 123 is a free end. This means the fourth ends 123b do not contact the conductive frame 121. A width of each of the second conductive arms 123 along the third direction D3 gradually narrows from the third end 123a to the fourth end 123b (i.e., from the fixed end to the free end).

Moreover, as shown in FIGS. 3-4, the first conductive arms 122 and the second conductive arms 123 at least partially overlap with each other along the third direction D3. In addition, the first conductive arms 122 and the second conductive arms 123 are alternately arranged along the third direction D3. Furthermore, the length of each of the first conductive arms 122 and the second conductive arms 123 is longer than half a width of the opening OP1 along the first direction D1.

Moreover, as shown in FIG. 4, another opening OP2 of the conductive slice 120 has a second inner edge 121b. The second inner edge 121b and the first inner edge 121a are arranged along the first direction D1 and spaced apart from each other. In addition, as shown in FIGS. 3-4, each of the conductive slices 120 further includes a plurality of third conductive arms 124 and a plurality of fourth conductive arms 125. The third conductive arms 124 are connected with the second inner edge 121b and extend at least partially along the first direction D1. Each of the third conductive arms 124 at least partially curves convexly towards another one of the conductive slices 120. The fourth conductive arms 125 are connected with the second inner edge 121b and extend at least partially along the second direction D2. Each of the fourth conductive arms 125 at least partially curves convexly towards another one of the conductive slices 120. The third conductive arms 124 and fourth conductive arms 125 are staggered relative to each other. In practice, when the conductive portion of another connector is inserted between the conductive slices 120, the conductive portion also abuts against the convexly curved portions of the third conductive arms 124 and the fourth conductive arms 125 respectively, such that the third conductive arms 124 and the fourth conductive arms 125 are at least partially deformed elastically, and the connecting stability of the conductive portion to the third conductive arms 124 and the fourth conductive arms 125 is increased. The convexly curved portions of the third conductive arms 124 and the fourth conductive arms 125 are respectively the third contact zones Z3 and the fourth contact zones Z4. The third contact zones Z3 of the third conductive arms 124 are arranged in a row. The fourth contact zones Z4 of the fourth conductive arms 125 are also arranged in a row. In the first direction D1, a distance from the third contact zones Z3 of the third conductive arms 124 to their fixed ends is longer than a distance to their free ends, but shorter than a distance to the fixed ends of the fourth conductive arms 125, while a distance from the fourth contact zones Z4 of the fourth conductive arms 125 to their fixed ends is longer than a distance to their free ends, but shorter than a distance to the fixed ends of the third conductive arms 124. Therefore, the third contact zones Z3 of the third conductive arms 124 and the fourth contact zones Z4 of the fourth conductive arms 125 are staggered relative to each other. When the conductive portion is inserted, the conductive portion sequentially contacts with the first contact zones Z1 of the first conductive arms 122, the second contact zones Z2 of the second conductive arms 123, the third contact zones Z3 of the third conductive arms 124 and the fourth contact zones Z4 of the fourth conductive arms 125. In this way, the insertion and extraction force required when the conductive portion is inserted into or extracted from between the conductive slices 120 can be reduced.

To be specific, as shown in FIG. 4, each of the third conductive arms 124 has a fifth end 124a and a sixth end 124b opposite to the fifth end 124a. The fifth end 124a of each of the third conductive arms 124 is a fixed end and is connected with the second inner edge 121b of the conductive frame 121. The sixth end 124b of each of the third conductive arms 124 is a free end. This means the sixth ends 124b do not contact the conductive frame 121. A width of each of the third conductive arms 124 along the third direction D3 gradually narrows from the fifth end 124a to the sixth end 124b (i.e., from the fixed end to the free end). Each of the fourth conductive arms 125 has a seventh end 125a and a eighth end 125b opposite to the seventh end 125a. The seventh end 125a of each of the fourth conductive arms 125 is a fixed end and is connected with the second inner edge 121b of the conductive frame 121. The eighth end 125b of each of the fourth conductive arms 125 is a free end. This means the eighth ends 125b do not contact the conductive frame 121. A width of each of the fourth conductive arms 125 along the third direction D3 gradually narrows from the seventh end 125a to the eighth end 125b (i.e., from the fixed end to the free end).

Moreover, as shown in FIGS. 3-4, the third conductive arms 124 and the fourth conductive arms 125 at least partially overlap with each other along the third direction D3. In addition, the third conductive arms 124 and the fourth conductive arms 125 are alternately arranged along the third direction D3.

Furthermore, in this embodiment, as shown in FIG. 4, the third conductive arms 124 and the second conductive arms 123 are alternately arranged along the third direction D3, such that the first conductive arms 122 and the third conductive arms 124 align with each other, while the second conductive arms 123 and the fourth conductive arms 125 align with each other.

In practical applications, when the busbar connector 100 is used, the conductive portion of another connector is inserted between the conductive slices 120, and the conductive portion abuts against the convexly curved portions of the first conductive arms 122, the second conductive arms 123, the third conductive arms 124 and the fourth conductive arms 125 respectively, such that the quantity of contact points between the conductive portion and the conductive slices 120 for the flow of an electric current can be effectively increased. In practice, the conductive frame 121, the first conductive arms 122, the second conductive arms 123, the third conductive arms 124 and the fourth conductive arms 125 are of in integrally formed structure.

Moreover, since each of the conductive slices 120 has a flat form to provide a plurality of electrical contact points and so has a thinner thickness, in compliance with the size specifications of a busbar connector to be used in a server unit, each of the conductive plates 111 can have a thicker thickness than the terminals in a busbar connector of the prior art, which allows each of the conductive plates 111 to have a larger cross-sectional area for a better support for higher currents. In other words, the conductive slices 120 provide more contact points and larger contact area relative to the terminals in a busbar connector of the prior art. Moreover, each of the conductive slices 120 has a thinner thickness, while each of the conductive plates 111 has a plate shape with thicker thickness, which can transmit a higher current to and from the conductive portion of another connector. A thickness ratio of the conductive plate 111 of each of the bodies 110 to the conductive frame 121 of each of the conductive slices 120 is greater than or equal to 3, preferably 6 or more.

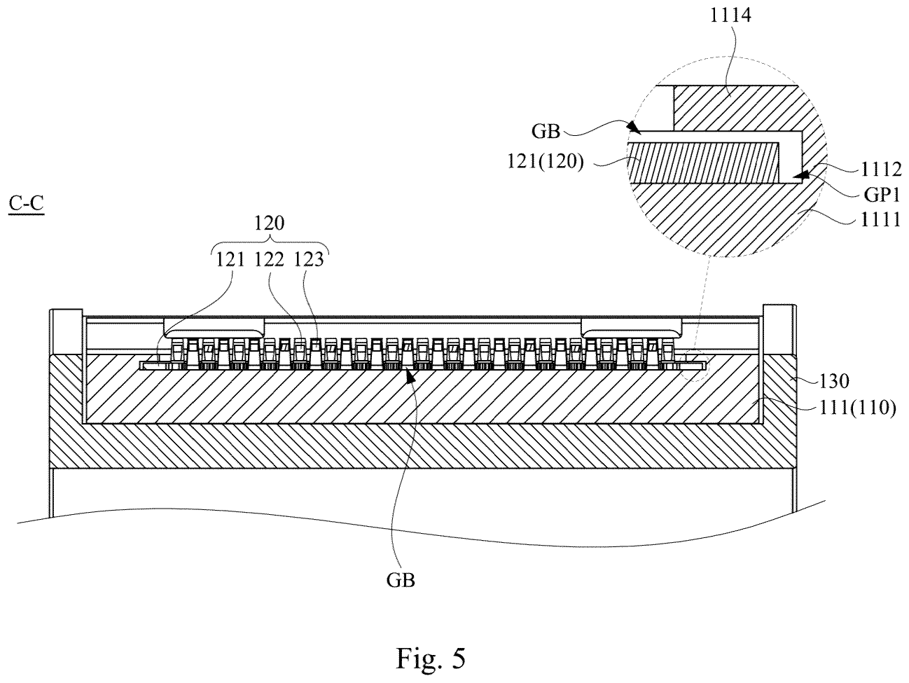

Reference is made to FIGS. 3 and 5. FIG. 5 is a sectional view along the sectional line C-C of FIG. 3. In the structural point of view, as shown in FIGS. 3 and 5, each of the conductive plates 111 includes a plate body 1111, two first sidewalls 1112, a second sidewall 1113, two first limiting portions 1114 and a second limiting portion 1115, to define a mounting groove GB. At least two side edges (i.e., a portion of the conductive frame 121) of each of the conductive slices 120 are mounted at the mounting grooves GB, such that the conductive slice 120 and the body 110 are electrically connected. The plate body 1111 supports the conductive frame 121 of the conductive slice 120. The first sidewalls 1112 are connected with the plate body 1111. The conductive frame 121 is located between the first sidewalls 1112. The second sidewall 1113 is connected between the first sidewalls 1112. Each of the first sidewalls 1112 is connected between the plate body 1111 and a corresponding one of the first limiting portions 1114, such that the first limiting portion 1114 and the plate body 1111 form a first gap GP1 therebetween, and the conductive frame 121 is at least partially located in the first gap GP1. This means the conductive frame 121 is at least partially sandwiched between the first limiting portion 1114 and the plate body 1111. The second limiting portion 1115 is connected between the first limiting portions 1114. The second sidewall 1113 is connected between the plate body 1111 and the second limiting portion 1115, such that the second limiting portion 1115 and the plate body 1111 form a second gap GP2 therebetween, and the conductive frame 121 is at least partially located in the second gap GP2. This means the conductive frame 121 is at least partially sandwiched between the second limiting portion 1115 and the plate body 1111. As shown in FIG. 3, the conductive frame 121 is at least partially sandwiched between the second sidewall 1113 and the housing 130, which prevents the conductive slices 120 from detaching from the conductive plates 111.

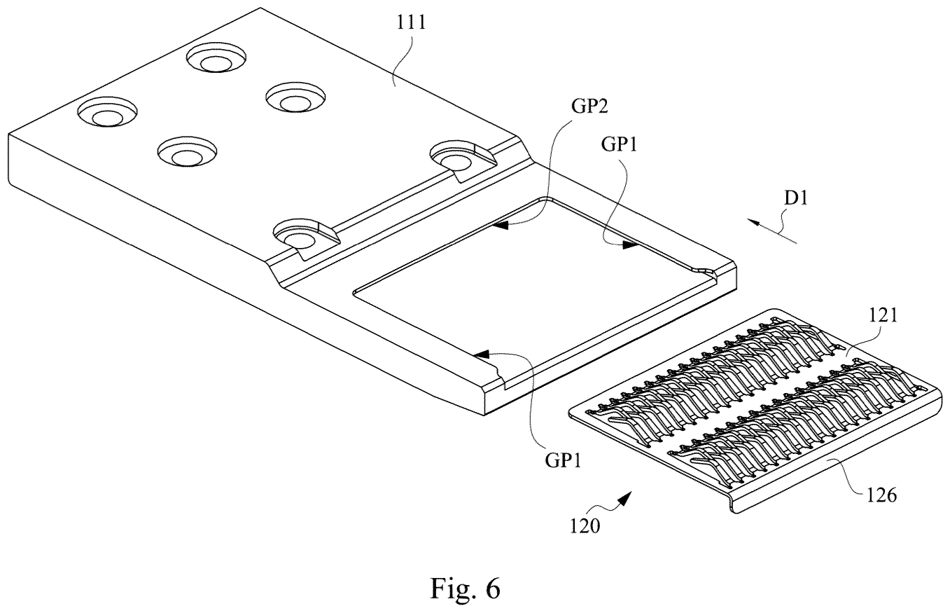

Reference is made to FIG. 6. FIG. 6 is a schematic view showing the way to install the conductive slice 120 to the conductive plate 111 of FIG. 1. For the sake of drawing simplification, the portions other than the conductive plate 111 and the conductive slice 120 are not shown in FIG. 6. A side of the conductive slice 120 can be bent and extended to form a positioning slice 126. In practice, when the conductive slice 120 is mounted to the mounting groove GB of the conductive plate 111, as shown in FIG. 6, the conductive slice 120 can be slid into the conductive plate 111 at the first gaps GP1 along the first direction D1, until the conductive slice 120 at least partially enters into the second gap GP2 of the conductive plate 111, and the positioning slice 126 abuts against a front end of the conductive plate 111 of the body 110. Afterwards, the conductive plate 111 mounted with the conductive slice 120 is inserted into the housing 130 through an installing opening at the back of the housing 130 until the conductive slice 120 is exposed from the slot GA at the front of the housing 130. At this point, the positioning slice 126 is sandwiched between the front of the conductive plate 111 and an inner wall at the front of the slot GA, and the assembly is completed. As shown in FIG. 3, at this point, the conductive frame 121 is at least partially sandwiched between the second sidewall 1113 and the housing 130, such that the conductive slice 120 is fixed on the conductive plate 111.

In conclusion, the aforementioned embodiments of the present disclosure have at least the following advantages:
(1) When the busbar connector is used, the conductive portion of another connector is inserted between the conductive slices, and the conductive portion abuts against the convexly curved portions of the first conductive arms, the second conductive arms, the third conductive arms and the fourth conductive arms respectively, such that the quantity of contact points between the conductive portion and the conductive slices for the flow of an electric current can be effectively increased, and the allowable magnitude of current flowing through the busbar connector is effectively increased.
(2) Since each of the conductive slices has a flat form to provide a plurality of electrical contact points and so has a thinner thickness, in compliance with the size specifications of a busbar connector to be used in a server unit, each of the conductive plates can have a thicker thickness, which allows each of the conductive plates to have a larger cross-sectional area for a better support for higher currents.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A busbar connector, comprising:
two bodies respectively being in a flat plate form, the bodies being opposite to and spaced apart from each other; and
two conductive slices, each of the conductive slices being disposed on a corresponding one of the bodies, the conductive slices facing to and being spaced apart from each other, each of the conductive slices comprising:
a conductive frame connected with the body and having a first inner edge;
a plurality of first conductive arms connected with the first inner edge and extending at least partially along a first direction, each of the first conductive arms at least partially curving convexly towards another one of the conductive slices; and
a plurality of second conductive arms connected with the first inner edge and extending at least partially along a second direction, the second direction being opposite to the first direction, each of the second conductive arms at least partially curving convexly towards another one of the conductive slices, the first conductive arms and second conductive arms being staggered relative to each other,
wherein a thickness ratio of the bodies to the conductive frames is greater than or equal to 3.

2. The busbar connector of claim 1, wherein the first conductive arms and the second conductive arms are alternately arranged along a third direction, the third direction is perpendicular to the first direction and the second direction.

3. The busbar connector of claim 2, wherein each of the first conductive arms has a first contact zone, the first contact zones are arranged in a row, each of the second conductive arms has a second contact zone, the second contact zones are arranged in a row, the first contact zones and the second contact zones are staggered relative to each other along the first direction.

4. The busbar connector of claim 1, wherein the conductive frame of each of the conductive slices has a second inner edge, the second inner edge and the first inner edge are arranged along the first direction and spaced apart from each other, each of the conductive slices further comprises:
a plurality of third conductive arms connected with the second inner edge and extending at least partially along the first direction, each of the third conductive arms at least partially curving convexly towards another one of the conductive slices; and
a plurality of fourth conductive arms connected with the second inner edge and extending at least partially along the second direction, each of the fourth conductive arms at least partially curving convexly towards another one of the conductive slices, the third conductive arms and fourth conductive arms are staggered relative to each other.

5. The busbar connector of claim 4, wherein the third conductive arms and the fourth conductive arms are alternately arranged along the third direction, the third direction is perpendicular to the first direction and the second direction.

6. The busbar connector of claim 4, wherein each of the first conductive arms has a first contact zone, the first contact zones are arranged in a row, each of the second conductive arms has a second contact zone, the second contact zones are arranged in a row, each of the third conductive arms has a third contact zone, the third contact zones are arranged in a row, each of the fourth conductive arms has a fourth contact zone, the fourth contact zones are arranged in a row, the first contact zones, the second contact zones, the third contact zones and the fourth contact zones are staggered relative to each other along the first direction.

7. The busbar connector of claim 1, wherein each of the bodies comprises a conductive plate, the conductive plate has a mounting groove to support at least a portion of the conductive frame.

8. The busbar connector of claim 1, wherein each of the conductive slices further comprises a positioning slice formed by bending and extending from a side of the conductive slice.

9. A busbar connector, comprising:
a housing having a slot;
two bodies respectively being in a flat plate form, the bodies being opposite to and spaced apart from each other, the bodies being partially exposed from the slot; and
two conductive slices, each of the conductive slices being disposed on a corresponding one of the bodies, the conductive slices facing to and spaced apart from each other, the conductive slices being partially exposed from the slot, wherein each of the conductive slices comprises a conductive frame and a plurality of conductive arms extending convexly inwards from an inner edge of the conductive frame, a thickness ratio of the bodies to the conductive frames is greater than or equal to 3.

10. The busbar connector of claim 9, wherein each of the bodies has a plurality of mounting grooves, at least two side edges of each of the conductive slices are mounted at the mounting grooves.

11. The busbar connector of claim 10, wherein each of the conductive slices comprises a positioning slice formed by bending and extending from a side of a corresponding one of the conductive slices, the positioning slice abuts an end of a corresponding one of the bodies when a corresponding one of the conductive slices is mounted at the mounting grooves.

12. The busbar connector of claim 9, wherein the conductive arms have at least two rows of contact zones staggered relative to each other.

13. The busbar connector of claim 9, wherein the housing is disposed with two grounding slices at each of two outer sides of the slot, each of the grounding slices is spaced apart from the bodies.

14. The busbar connector of claim 9, wherein each of the bodies further comprises:
a conductive plate, a corresponding one of the conductive slices is disposed on the conductive plate; and
at least one conductive extending piece connected with a side of the conductive plate away from the corresponding one of the conductive slices.

15. The busbar connector of claim 14, wherein each of the bodies further comprises at least one conductive connecting piece, a quantity of the conductive extending piece is plural, the conductive connecting piece penetrates through and fixes the conductive extending pieces.

16. The busbar connector of claim 15, wherein the conductive connecting piece comprises a bolt and a nut.

17. The busbar connector of claim 14, wherein the housing comprises a plurality of positioning structures therein, each of the bodies further comprises:
a plurality of positioning elastic arms disposed on a side of the conductive extending piece away from the conductive plate, each of the positioning elastic arms extends along an extending direction of the conductive extending piece and is at least partially lifted up relative to the conductive extending piece, each of the positioning elastic arms is configured to snap with a corresponding one of the positioning structures.

18. The busbar connector of claim 9, further comprising:
two grounding slices disposed on the housing at two outer sides of the slot, each of the grounding slices has an L shape.

19. The busbar connector of claim 9, wherein the slot has a front opening and two side openings communicated with the front opening.
